(19) United States
(12) Patent Application Publication
(10) Pub. No.: US 2010/0192866 A1
(43) Pub. Date: Aug. 5, 2010

(54) Disposable hummingbird feeder

(76) Inventor: Joseph E. McMullen, Greenville, SC (US)

Correspondence Address: Patent Colsultants & Services, Inc., 204 Bouchillion Drive, Greenville, SC, 29615, US

(21) Appl. No.: 12/322,459

(22) Filed: Feb. 3, 2009

(51) Int. Cl. A01K 39/00

(52) U.S. Cl. 119/77; 119/74

(57) ABSTRACT

The hummingbird feeder of this invention has an initial storage and shipping configuration and a final feeding configuration. In a first embodiment, a transparent fluid reservoir contains a feeding solution that is dispensed through a punctured thin diaphragm into a cap cavity of a bottom cap threaded on the reservoir. In a second embodiment a removable sealer cap initially keeps the feeding solution in the reservoir. In a third embodiment, the feeding solution is dispensed by removing a “peel-away” diaphragm from the reservoir. Each feeding assembly has a red feeding guide and a feeding tube with an aperture for the hummingbird to access the feeding solution. Perches supported by the bottom cap are provided for the hummingbirds to rest. The feeding solution is made aseptic and bacteria free to help keep it from spoiling. The top of the fluid reservoir has a moat filled with an insect inhibiting material to protect against insects and ants reaching the feeding solution. A label can be placed on the reservoir to provide logo, legal information, directions for use, essential safety warnings and red coloring to attract hummingbirds.

### BACKGROUND OF THE INVENTION

This invention is directed to hummingbird feeder and more particularly to an economical feeder design using biodegradable or recyclable materials so that it can be discarded or the material reused after use. In particular, the feeder has only essential parts that can be easily produced to provide the necessary components to be a low cost, effective and safe feeder for one or more hummingbirds to feed.

The most commonly used hummingbird feeders are configured to have a top reservoir portion, containing a nectar, coupled to a bottom portion having a feeding region for the hummingbird to access the nectar. For most feeders a problem exists as a result of the use of high sugar content in the nectar. A critical problem exists when the nectar spoils resulting in the health of the hummingbird being endangered. The feeding solution spoils and becomes contaminated within a relatively short period of time. Spoilage results in the accumulation of mold slime and the sugar turns to alcohol. In hot weather this can be as short as two days, unless steps are taken to extend this time. Physical changes in the feeding solution occur with spoilage; such as changes in acid Ph content, specific gravity, presence of alcohol, presence of bacteria and the like. The results of the chemical reaction and contamination of the feeding solution endangers the health of the birds being fed. These changes can be used to indicate removal of the feeder when necessary. Feeders can also present health risks to humans. Cleaning of the reusable feeder is a multi-step process and must be frequent to maintain a desirable and safe level of performance. Adequate cleaning is difficult for several reasons, requiring the use of a variety of brushes to clean the interior parts. For example, the feeding apertures are very small to accommodate the beak of a hummingbird; having an opening of about one-eighth of an inch. Proper cleaning is critical for reusing a feeder. In addition, the preparation and processing of the nectar should be done with utmost care before the feeder can be returned to service. The proper mixture ratios and attention to the risk of contamination are critical to provide an aseptic solution.

A further contamination of many conventional hummingbird feeders results from ants and other crawling insects. The ants and insects travel down the hangar portion to reach the top reservoir and feeding region. In tests, conventional hummingbird feeders were found to require frequent cleaning in order to remove accumulated ants or insects.

Therefore, the process of cleaning hummingbird feeders is time consuming, messy and unsanitary process that detracts from the enjoyment of feeding hummingbirds. This deters many from continuing to use their feeders and many users simply refill the hummingbird feeder with a fresh feeding solution, while foregoing the cleaning process. It has become a popular pastime of adults and children to feed and watch hummingbirds at a feeder. It also serves a purpose of providing necessary food for the birds. If the dangers associated with simply refilling the feeder were known to the public, the practice of refilling feeders would be curtailed.

A need exists to provide a hummingbird feeder which has a configuration that is used prior to the sale of the feeder to insure a contamination free feeding solution for shipping and storage. The feeder also needs to be easily converted to a second configuration when placed in use. In addition, an economical feeder design, which discourages refilling and allows for safe disposal of the used feeder, should help eliminate the unsafe reuse of the feeder.

Commonly used hummingbird feeders typical of the industry are disclosed in U.S. Pat. Nos./Application Numbers: 7,275,500; 7,234,418; 7,093,562; 7,040,251; 6,834,616; 5,507,249; 5,269,258; 4,938,168; 4,901,673; 4,558,662; D542,459; D514,749; D454,669; 2007/0006813; and 2004/0244704. The '500, '251 and '616 patents by Fort II discloses a dome or cylindrical shaped container with threads that mate with a base threads of a base. A selector is provided in the base to dispense large or small seeds from the feeding ports. The '418 patent discloses a hummingbird feeder which can be taken apart for easier maintenance. The '562 patent and the '6813 patent application by Smothers discloses various means to lock a feeding assembly to the reservoir to help prevent refilling without damaging the feeding assembly. The '249 patent discloses three threaded together parts of the feeder including a cover and mote, a globular reservoir and a block and support for the feeding stations. The “673 patent discloses an upward opening receptacle at the top of the reservoir filled with an insect inhibiting fluid to provide an effective barrier for ants and insects from reaching the feeding solution. None of these patents disclose a disposable hummingbird feeder having the economical, contamination free and disposable design of the present invention. A major contamination problem exits when the user is allowed to fill the feeder prior to placing the feeder in service. Some feeders apply to using bird seed only and are not a liquid bird feeder.

The need remains to clearly inform the user of the danger to the hummingbird in reusing a hummingbird feeder. A simple low cost biodegradable or recyclable feeder design is critical so that the user has no problem in disposing of the used feeder and replacing it with another one. In addition, the feeding solution can spoil and become contaminated prior to being consumed. No indication of a safe-to-use feeding solution indicator was found in the art. Protection against contamination of the all components of the hummingbird feeder during storage and shipping of the feeder should also be provided. Additional consideration was given in the present invention to the fact that the hummingbird has a long slender beak and remains in a hovering motion while feeding. The length of the feeding tube can also be made to be adjustable for hummingbirds of different size.

These needs remain unfulfilled.

Inasmuch as the art is relatively crowded with respect to hummingbird feeders, it can be appreciated that there is a continuing interest in providing improvements to such hummingbird feeders. In this respect, the present invention addresses this need and interest.

Accordingly, it is the objective an object of the present invention is to provide a hummingbird feeder with a simple and rugged design that readily attracts hummingbirds, is easily placed into service, safe and easy to use and economical to make.

An essential object is to provide one configuration of the feeder for safe shipping and storage and another configuration for feeding the hummingbird when placed into service.

One object of the present invention is to provide a hummingbird feeder that is clearly marked to be harmful to hummingbirds if it is refilled to be used again.

Another object of the present invention is to provide a hummingbird feeder with a relatively small but sterile volume of feeding solution that can be kept aseptic and bacteria free.

Yet another of the present invention is to provide feeder tubes that can be adjusted for different size hummingbirds to feed.

Another essential object of the present invention is to provide a means to protect the feeding solution from contamination by ants and other insects when in use.

Another essential object of the present invention is to provide the user with the convenience of a filled single use feeder which is biodegradable or recyclable, thus eliminating the cleaning and solution preparation tasks and the danger to the environment when disposed of.

### SUMMARY OF THE INVENTION

The present invention combines a classical hummingbird feeder with the disposable features that make it safe and easy to use. The feeder has a first initial storage and shipping configuration and a second final feeding configuration when used. Conversion from the first to the second configuration is provided by an interface unit. There are three embodiments of the interface unit defined by different components used at the interface between a transparent fluid reservoir and a bottom cap threaded on the reservoir. In a first embodiment of the invention, the reservoir contains a feeding solution that is held in the reservoir by a thin diaphragm and kept safe until dispensed by bottom cap puncturing the diaphragm so that the feeding solution flows into a cap cavity of the bottom cap fully threaded on the reservoir. In a second embodiment of the invention, the interface unit is a sealer cap which has a bottom portion threaded into the bottom cap and a top portion threaded on the reservoir. The sealer cap is completely removed so that the bottom cap can be completely threaded onto the reservoir to allow the feeding solution to flow into the cap cavity of the bottom cap when the feeder is inverted. In a third embodiment of the invention the feeding solution is kept safe by a “peel-away” diaphragm on the reservoir which is completely removed between unthreading and replacing the bottom cap. This allows the feeding solution to flow into the cap cavity of the bottom cap which is fully rethreaded on the reservoir.

A plurality of feeding assemblies are each supported by a cap sleeve in the bottom cap. Each feeding assembly has a red feeding guide and a feeding tube with a feeding tube aperture for the hummingbird to access the feeding solution in the cap cavity. Perches supported by the bottom cap can be provided for the hummingbirds to rest. The feeding solution is added to the reservoir prior to the point-of-sale. The top of the fluid reservoir has a moat that can be filled with an insect inhibiting material to protect against insects and ants reaching the feeding solution. A label can be placed on the reservoir to provide logo, legally mandated information, directions for use and disposal, essential safety and contamination warnings, assembly instructions and red coloring to attract the hummingbirds.

The above objectives are accomplished according to the present invention by providing a disposable hummingbird feeder. The feeder comprises a transparent fluid reservoir filled with a feeding solution. The feeder has a closed and recessed top and an open cylindrical bottom portion with external threads between a bottom flange and a bottom edge of the reservoir. A bottom cap, having a cylindrical cap cavity with internal cap threads that mesh with the external threads of the fluid reservoir. An interface unit provides a first storage and shipping configuration of the feeder, wherein the feeding solution is sealed within said reservoir, and a second feeding configuration of the feeder, wherein the feeding solution enters the bottom cap cavity to be accessed by the hummingbird. The bottom cap has cap sleeves and a top edge so that, in the first storage and shipping configuration, the top edge of the bottom cap is spaced apart from the bottom flange of said reservoir and, in the second feeding configuration, the top edge of the bottom cap contacts the bottom flange of the reservoir to allow the feeding solution to enter the cap cavity. A plurality of feeding assemblies, each positioned in a respective cap sleeve of the bottom cap, to provide feeding apertures for the hummingbirds to access the feeding solution when the bottom cap is in the second feeding configuration.

In one aspect of the invention the bottom cap is formed with a plurality of perch supports that correspond with the plurality of feeding assemblies, The perch supports are each supporting a perch that extends approximately vertical in the storage and shipping configuration of the feeder and is moved to approximately a horizontal position in the feeding configuration of the feeder, so that the hummingbirds can rest when using the feeder.

In another aspect of the invention the fluid reservoir, the bottom cap, the interface unit, the feeding assemblies and the perches are all made of a material that is either biodegradable or reusable, so that the feeder can be discarded or recycled without being a waste hazard.

In an additional aspect of the invention each feeding assembly includes a feeding tube with a guide and a center aperture held in the cap sleeve of the bottom cap by friction so that the feeding tube provides the proper distance between a feeding guide and the feeding solution in the cap cavity for the feeding hummingbird.

In a further aspect of the invention the recessed top portion of the cylindrical reservoir includes a hangar tab with an aperture to receive a hangar to hang the hummingbird feeder in an optimum location. The recessed top portion also provides a moat to receive an insect inhibiting material to form a barrier against insects reaching the feeding solution.

In a critical aspect of the invention the feeding solution has been treated to produce a cleansing of the feeding solution to obtain an aseptic solution which is bacteria free for improving shelf-life of the feeder and making the feeding solution safe for consumption by the hummingbird.

In an aspect of the invention the external threads of the fluid reservoir mesh with the cap threads to form a locking mechanism to help keep the hummingbird feeder from being reused by adding more feeding solution to the fluid reservoir.

In a first embodiment of the invention the interface unit comprises a thin diaphragm attached to the bottom edge of the reservoir to retain the feeding solution within the reservoir during the storage and shipping configuration. A protrusion built integral with the bottom cap that extends upward into the cylindrical cap cavity to penetrate the diaphragm when the bottom cap is threaded onto said reservoir to said second feeding position.

In a second embodiment of the invention the interface unit comprises a reservoir sealer cap having an upper portion with internal threads that mesh with the external threads of the reservoir, and a bottom portion with external threads that mesh with the internal cap threads of the bottom cap.

The sealer cap is threaded onto the reservoir to seal the feeding solution within the reservoir and the bottom cap is threaded onto the sealer cap to provide the first storage and shipping configuration. The sealer cap is completely removed and the bottom cap is threaded onto the external threads of the reservoir to provide the second feeding configuration of the feeder.

In a third embodiment of the invention, a disposable hummingbird feeder assembly comprises a transparent fluid reservoir filled with a feeding solution. The hummingbird feeder has a closed top portion with a top recess forming a moat with a hangar tab for a hangar and an open cylindrical bottom portion with external threads between a bottom flange and a bottom edge of the reservoir. An interface unit comprising a “peel-away” diaphragm is supported by and sealed against the bottom edge of the reservoir to initially retain the feeding solution within the reservoir. A bottom cap has a top surface, a cylindrical cap cavity with internal cap threads that mesh with the external threads of the reservoir, a bottom surface and a plurality of perch supports each with a cap sleeve. The feeder has a first storage and shipping configuration where the bottom cap is partially threaded onto the reservoir until the top edge of the bottom cap is spaced apart from the bottom flange of the reservoir. The feeder has a second feeding configuration where the peel-away diaphragm is removed from the bottom edge of the reservoir and the bottom cap is threaded onto the reservoir until the top edge of the bottom cap contacts the bottom flange of the reservoir. The feeding solution flows into the cap cavity to be accessed by the hummingbird through the feeding assemblies when the feeder is hanging in an optimum location using the hangar. A plurality of feeding assemblies, each supported by the bottom cap using a respective cap sleeve, provide feeding apertures for the hummingbird to access the feeding solution.

In another aspect of the third embodiment the feeding solution again is a twenty (20) percent sucrose invert which has been treated to produce a cleansing of the feeding solution to obtain an aseptic solution which is bacteria free. This treatment improves shelf-life of the feeding solution and keeps the feeding solution safe for consumption by the hummingbird; as seen by an obvious change in appearance of said feeder solution when the feeding solution becomes unsafe.

In a general aspect of the second embodiment of the invention a method to provide a disposable hummingbird feeder includes the following steps. The method has a first step of providing a transparent fluid reservoir having a closed and recessed top with a hangar and an open cylindrical bottom portion with external threads between a bottom flange and a bottom edge. A second step includes providing a reservoir sealer cap having a top portion with internal threads that mesh with said external threads of said reservoir and a bottom portion with external threads between a sealer diaphragm and a bottom surface. In a third step the method includes providing a bottom cap having a cylindrical cap cavity with internal cap threads that mesh with the external threads of the sealer cap, perch supports with cap sleeves, a top flange and a bottom surface. A fourth step includes inverting the reservoir and filling the reservoir with a feeding solution. A fifth step includes threading the top portion of the sealer cap onto the reservoir and the bottom cap onto the bottom portion of the sealer cap to obtain a first storage and shipping configuration of the feeder prior to using the feeder. The sixth step of the method includes inverting the feeder and removing the bottom cap and sealer cap from the reservoir as a first step in placing the feeder into service. A seventh step includes removing the sealer cap from the bottom cap and threading the bottom cap onto the reservoir until it clicks through a semi-locked position. An eighth step includes providing and connecting perches to the perch supports and inserting feeding assemblies into the cap sleeves. In a ninth step the method includes inverting the feeder to obtain an upright feeding configuration allowing the feeding solution to enter the cylindrical cavity of the bottom cap to be retained by the bottom surface of the bottom cap. A tenth step includes hanging the feeder in an appropriate location using the hangar. In a eleventh step the method includes moving the perches to approximately a horizontal position so that the hummingbird can rest while accessing the feeding solution within the cap cavity through the feeding assemblies. The twelfth step includes disposing of the feeder when the feeding solution has become unsafe for consumption by the hummingbird or has been consumed.

In one aspect of the method the invention includes the step of making the fluid reservoir, the bottom cap, the perches and the feeding assemblies of a material which is one of either biodegradable or recyclable.

In a further aspect of the method for providing a disposable hummingbird feeder the step of providing a recessed top of the reservoir includes the step of adding a liquid material to form a mote against insects reaching said feeding solution and wherein the step of providing feeding assemblies further includes the steps of providing a red colored feeding guide in the form of a flower to attract a hummingbird, providing a feeding tube that is adjustably held in the cap sleeve of the bottom cap by friction so that the feeding tube slides in and out of the cap sleeve for providing the proper distance between the feeding guide and the feeding solution in the cap cavity and providing the feeding tube with an aperture for allowing access by the hummingbird to the feeding solution in the cap cavity of the bottom cap.

In yet another aspect of the method the step of filling the reservoir with a feeding solution includes the steps of treating the chemical substance to provide an aseptic solution that is bacteria free for improving the shelf life of the feeding solution and extending the useful life of the feeding solution.

In a further aspect of the above embodiments the cylindrical reservoir has a red label applied thereto having general logo, use and safety information printed thereon.

### DESCRIPTION OF THE DRAWINGS

The construction designed to carry out the invention will hereinafter be described, together with other features thereof.

The invention will be more readily understood from a reading of the following specification and by reference to the accompanying drawings forming a part thereof, wherein an example of the invention is shown and wherein:

FIG. 1 is a perspective view of a disposable hummingbird feeder of my new invention;

FIG. 2 is a front elevation view of the disposable hummingbird feeder of FIG. 1, the opposite side being a mirror image;

FIG. 3 is a left side elevation view of the disposable hummingbird feeder of FIG. 1;

FIG. 4 is a top view of the disposable hummingbird feeder of FIG. 1;

FIG. 5A is a bottom view of a first embodiment of the disposable hummingbird feeder of FIG. 1;

FIG. 5B is a bottom view of a second or third embodiment of the disposable hummingbird feeder of FIG. 1;

FIG. 6A is a cross-sectional view of the first embodiment of the hummingbird feeder of FIG. 1 taken along line 6-6 in FIG. 4;

FIG. 6B is a cross-sectional view of the second or third embodiment of the hummingbird feeder of FIG. 1 taken along line 6-6 in FIG. 4;

FIG. 7A is a cross-sectional view of the first embodiment of the disposable hummingbird feeder of FIG. 1 in a first shipping and storage configuration prior to use;

FIG. 7B is a cross-sectional view of the second embodiment of the disposable hummingbird feeder of FIG. 1 in a first shipping and storage configuration prior to use;

FIG. 7C is a cross-sectional view of the third embodiment of the disposable hummingbird feeder of FIG. 1 in a first shipping and storage configuration prior to use;

FIG. 8 is an exploded front elevation view of the disposable hummingbird feeder of FIG. 1 showing a transparent fluid reservoir and a bottom cap, the bottom cap having a cut-away showing internal cap threads that mesh and lock or semi-lock with external threads of the cylindrical bottom portion of the reservoir;

FIG. 9A is a cross-sectional view of the first embodiment of the bottom cap of the disposable hummingbird feeder of FIG. 1 taken along line 9A-9A in FIG. 10A;

FIG. 9B is a cross-sectional view of the second or third embodiment of the bottom cap of the disposable hummingbird feeder of FIG. 1 taken along line 9B-9B in FIG. 10B;

FIG. 10A is a plan view of the first embodiment of the bottom cap of the disposable hummingbird feeder of FIG. 1;

FIG. 10B is a plan view of the second or third embodiment of the bottom cap of the disposable hummingbird feeder of FIG. 1;

FIG. 11 is an enlarged partial cross-sectional view of the perch support and perch showing in detail the perch connection to the perch support of FIG. 6A or FIG. 6B;

FIG. 12 is an enlarged perspective view of one perch of the disposable hummingbird feeder of FIG. 1 and FIG. 11.

FIG. 13A is an elevation view of a reservoir sealer cap of the second embodiment of the disposable hummingbird feeder of FIG. 1; and

FIG. 13B is a cross-sectional view of the reservoir sealer cap taken along line 13-13 in FIG. 13A

### DESCRIPTION OF A PREFERRED EMBODIMENT

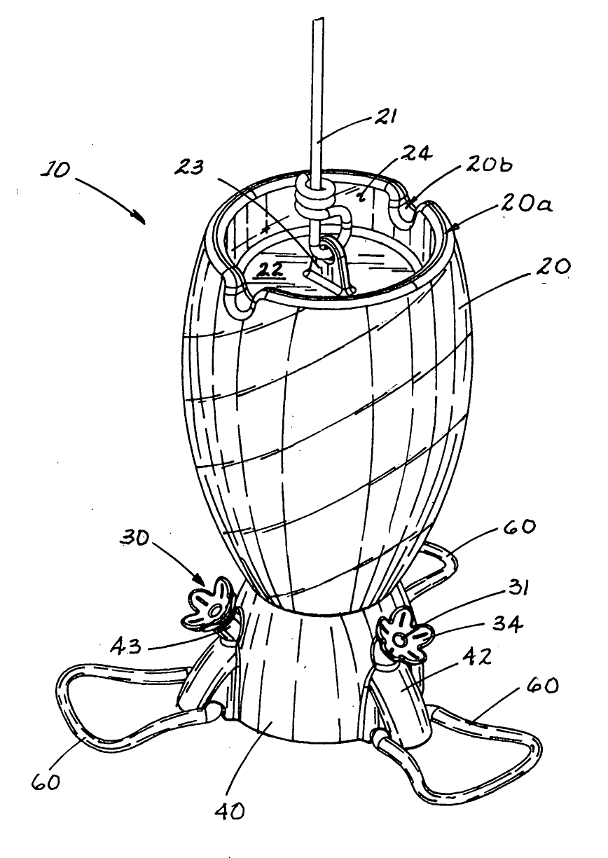

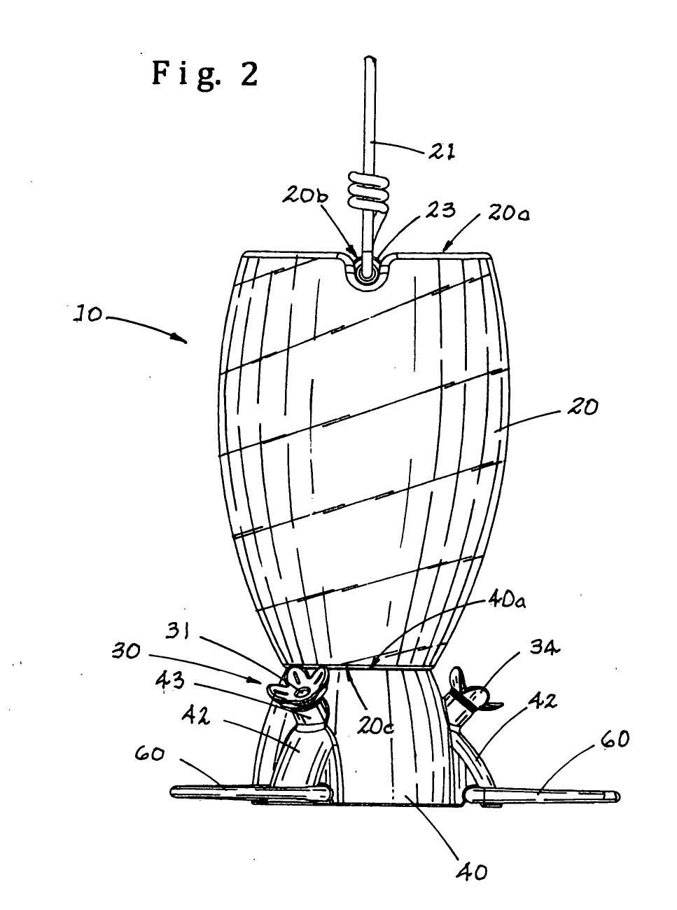

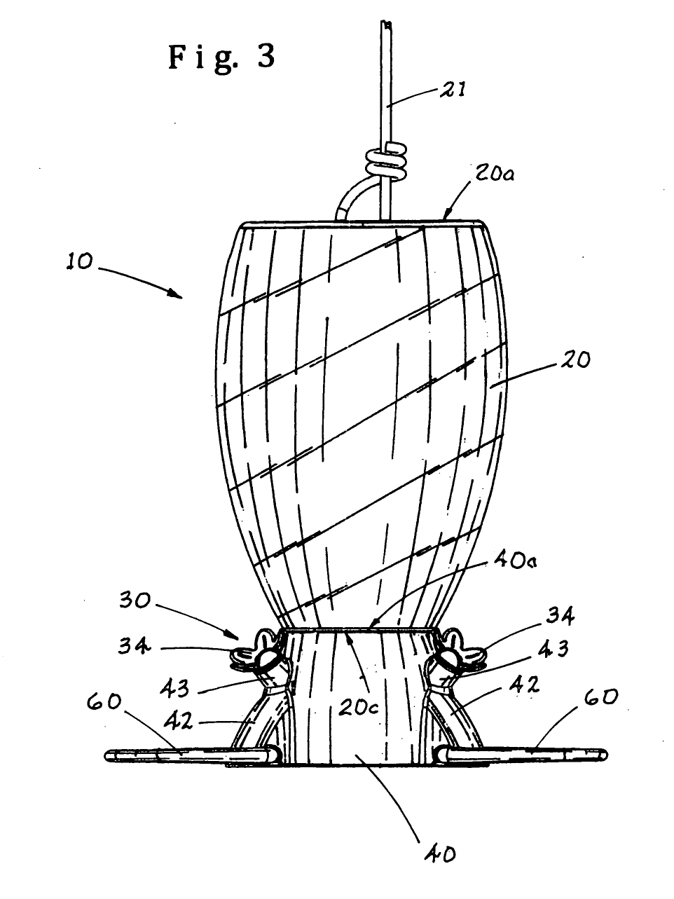

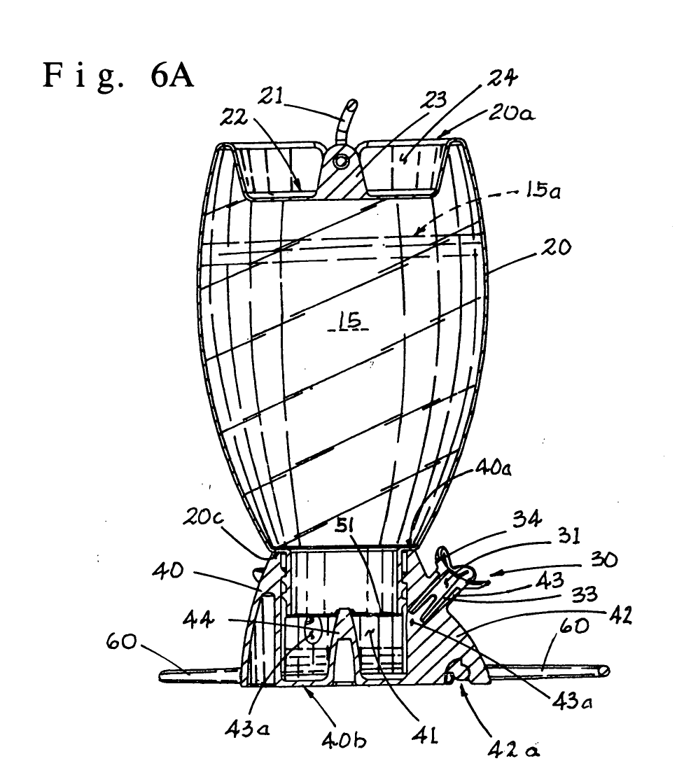

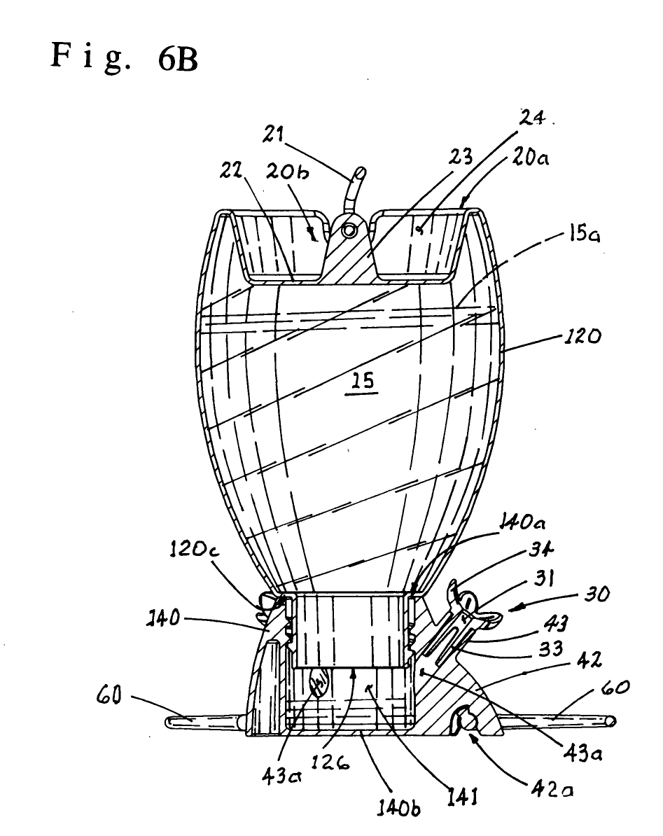

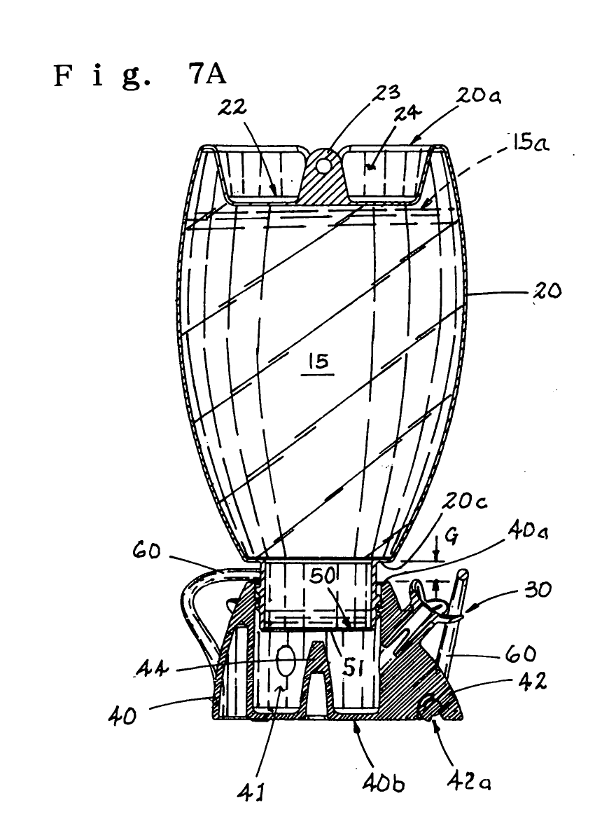

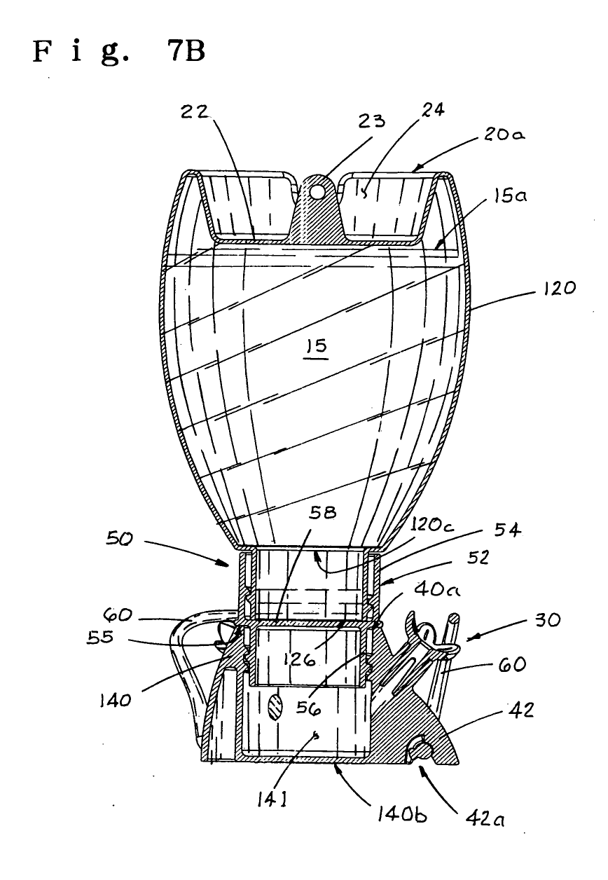

Referring now in more detail to the drawings, the invention will now be described in more detail. A perspective view of a hummingbird feeder 10 in a feeding configuration according to this invention is illustrated in FIG. 1. Elevation views are shown in FIG. 2 and FIG. 3. A transparent fluid reservoir containing a feeding solution has a bottom cap 40 threaded onto the reservoir. The feeding solution is accessed by a hummingbird through a plurality of feeding assemblies 30 each having a feeding aperture 31. The feeding assembly fits into a cap sleeve 43 and includes a red feeding guide 34 to help direct the hummingbird to the feeder. A top surface 20a of the fluid reservoir is flat but has a top recess 20b to provide a moat 24 with a bottom surface 22 to facilitate shipping and handling. The mote will be described in more detail below. A hangar 21 attached to a hangar tab 23 is provided to support the hummingbird feeder in an appropriate location. Perch supports 42 corresponding with each feeding assembly 30 support a perch 60 so the hummingbird can rest, if necessary. The size and shape of the fluid reservoir can vary within the scope of this invention, as illustrated by fluid reservoir 120 shown with the different embodiments (See FIGS. 6B, 7B and 7C).

A front elevation view of the feeder is shown in FIG. 2 and a side elevation view of the feeder is shown in FIG. 3. These elevation views best illustrate how fluid reservoir 20 and bottom cap 40 are threaded together so that a bottom flange 20c of the fluid reservoir and a top edge 40a of the bottom cap are in contact with one another when feeder 10 is positioned and configured for use; referred to herein as the second feeding configuration.

The preferred cross-sectional shape of the fluid reservoir is cylindrical. However, other polygonal shapes including rectangular and square with rounded corners are within the scope of this invention; as long as the bottom threaded portion is cylindrical. A top plan view of the hummingbird feeder is illustrated in FIG. 4 to show details of the top portion of fluid reservoir 20. The fluid reservoir has top surface 20a and recess 20b to form moat 24 with a bottom surface 22 to retain an insect inhibiting fluid. Hangar tab 23 extends upward from the bottom of the mote. A hangar aperture in the hangar tab receives hangar 21. The mote provides an effective barrier which prevents insects, and especially ants, from traveling down the hangar 21 to the feeding tube assemblies. The mote is made so that the insect inhibiting fluid completely surrounds the hangar tab.

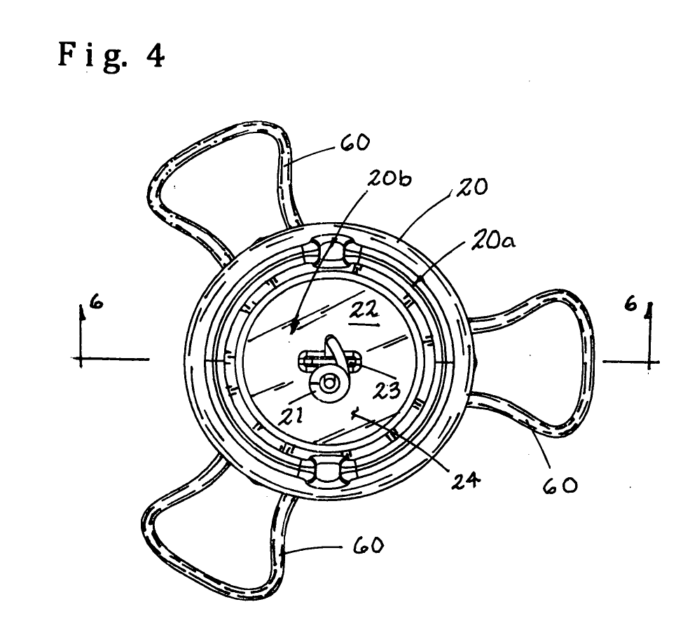

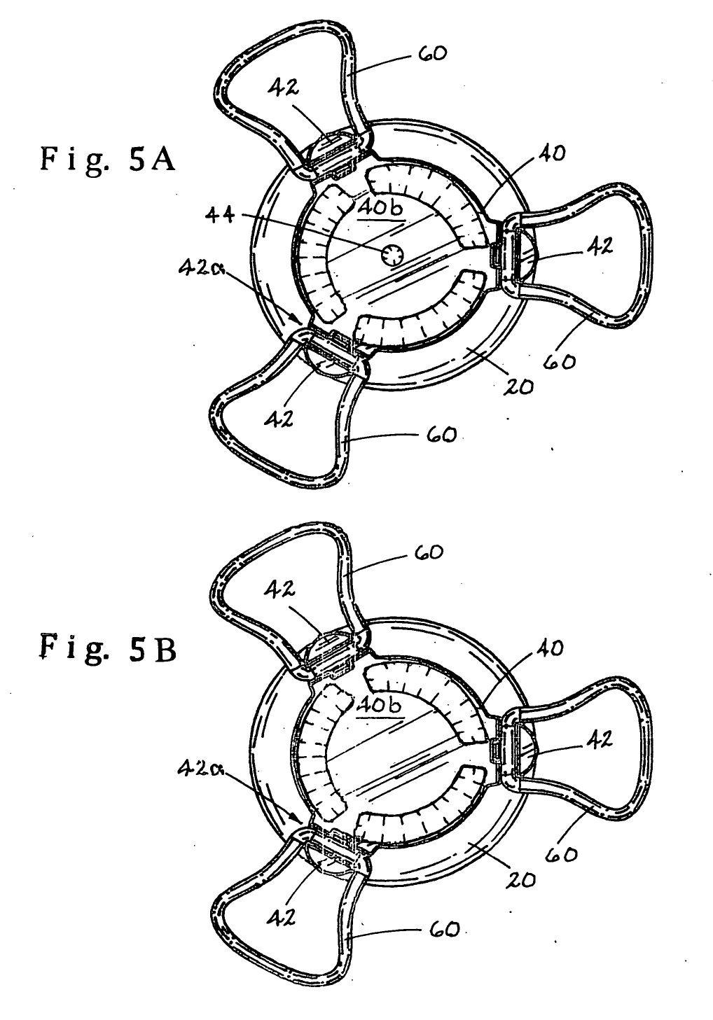

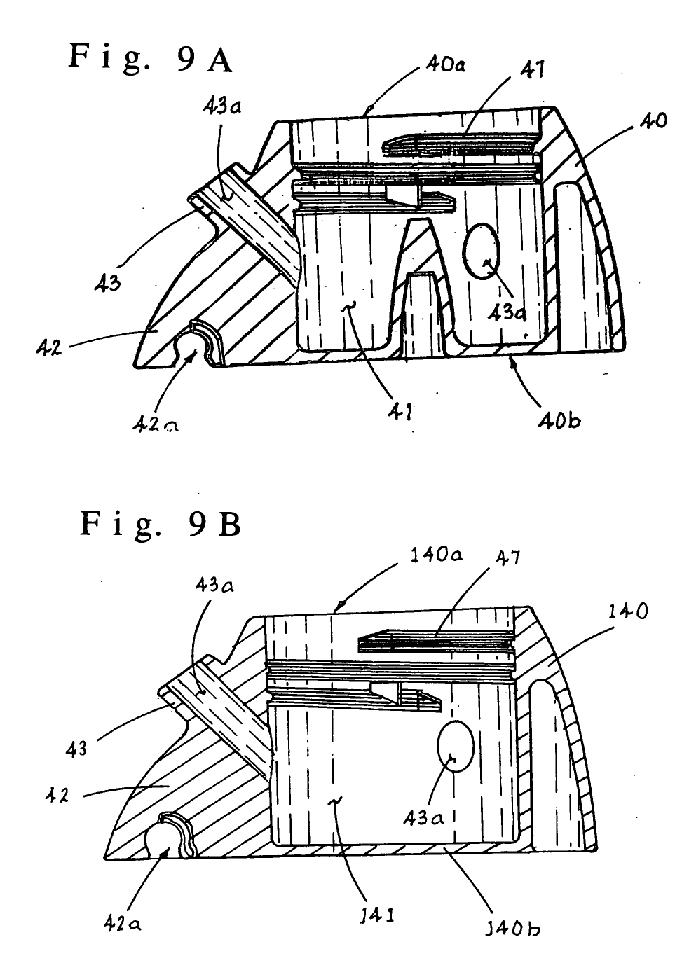

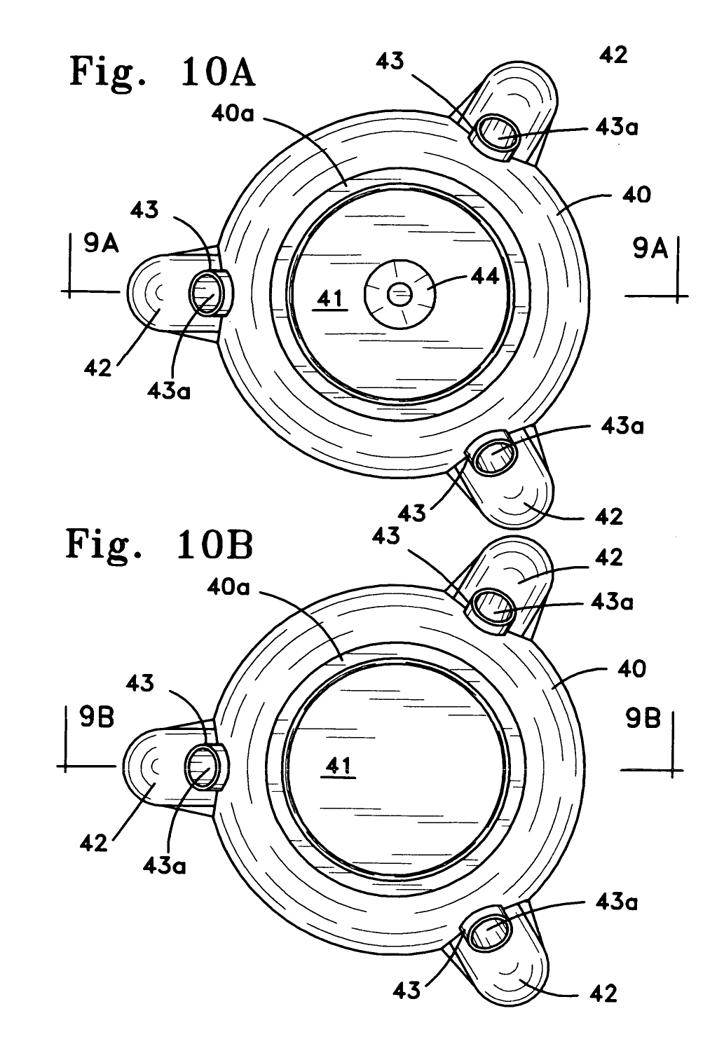

A bottom view of a first embodiment of the hummingbird feeder is illustrated in FIG. 5A. Perches 60 fit into recesses 42a in bottom surface 40b of perch supports 42 of bottom cap 40. The perches can rotate upward for the shipping and storage configuration prior to placing the feeder into use. The perches rotate downward to approximately the horizontal position shown during use. A bottom view for the second and third embodiments is illustrated in FIG. 5B. This view is essentially the same as FIG. 5A except for the center aperture due to component 44 is not present in this embodiment. The features of the bottom cap are illustrated in the cross-sectional views of FIGS. 9A and 9B and the plan views of FIGS. 10A and 10B and discussed in more detail later in this description.

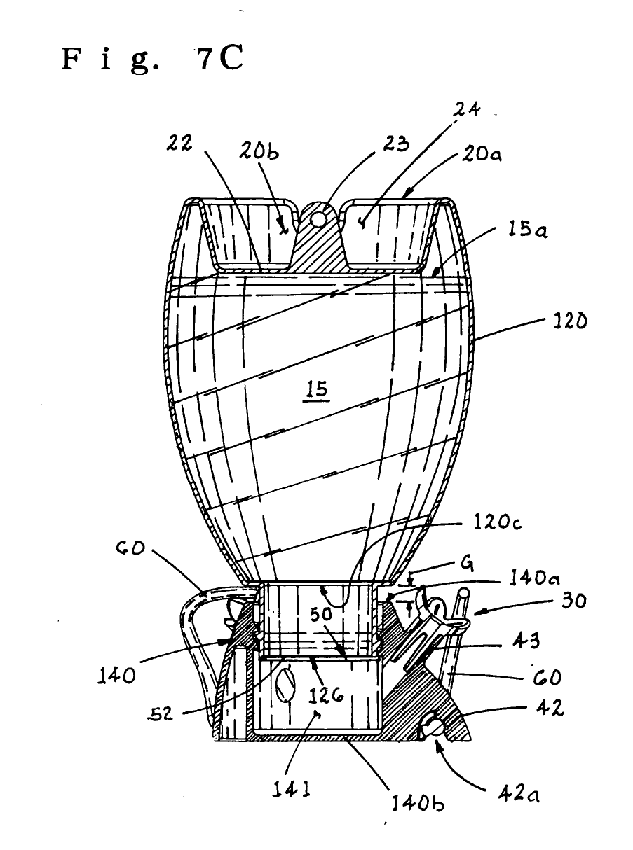

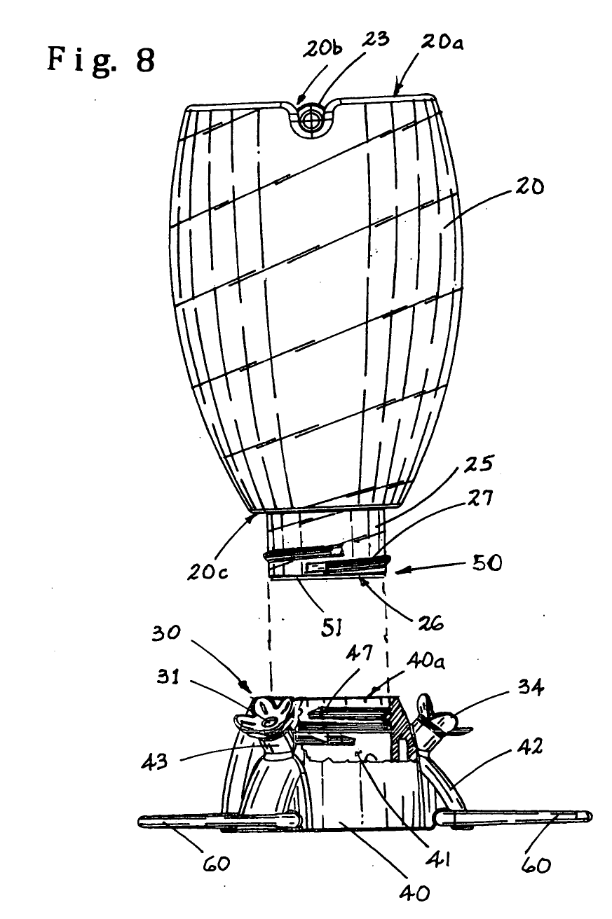

Details of the first embodiment of the hummingbird feeder are illustrated in the cross-sectional views of FIG. 6A and FIG. 7A and the exploded view of FIG. 8. The exploded view of FIG. 8 is discussed first to describe how the main components of the feeder are connected. Fluid reservoir 20 is filled with the feeding solution and an interface unit 50, being a thin diaphragm 51 for this embodiment, is bonded to a bottom edge 26 of the fluid reservoir. The thin diaphragm retains the feeding solution in the reservoir for the first storage and shipping configuration of the feeder. The cylindrical lower portion 25 of the reservoir, between bottom flange 20c and bottom edge 26, has external threads 27. A cylindrical internal cavity 41 of bottom cap 40 has internal cap threads 47 that mesh with threads 27 of the reservoir. In a first storage and shipping position the bottom cap is partially threaded onto the reservoir, (see gap “G”) as illustrated in FIG. 7A. In the second feeding configuration (see FIGS. 1-3), the bottom cap is fully threaded onto the reservoir until the top edge 40a of the bottom cap is in contact with bottom flange 20c of the reservoir, as illustrated in FIG. 6A. The threads 27 and 47 can be made to interlock one with the other to discourage removing the bottom cap and refilling the fluid reservoir. The intent is to dispose of the hummingbird feeder when it is empty or the feeding solution has spoiled. In addition, all components of the hummingbird feeder are made to be biodegradable or recyclable.

The first storage and shipping configuration of the first embodiment of the connected portions of the hummingbird feeder is discussed next by referring to the cross-sectional view of FIG. 7A. Internal cap cavity 41 of the bottom cap has a protrusion 44 extending upward into the cavity. In this first storage position of the feeder, there is a gap “G” between bottom flange 20c of the fluid reservoir and top edge 40a of the bottom cap. In this position, protrusion 44 does not contact thin diaphragm 51. Therefore, feeding solution 15 does not enter the internal cap cavity of the bottom cap. The fluid reservoir is initially filled with the feeding solution to a full level in the reservoir, as illustrated by horizontal dashed lines 15a. In addition, a perch 60 is placed in a perch recess 42a of each perch support 42 and can be rotated or folded up to save space during the first shipping and storage configuration of the feeder.

The second feeding configuration of the first embodiment of the connected portions of the hummingbird feeder is now discussed by referring to the cross-sectional view of FIG. 6A. The cross-sectional view of FIG. 6A is taken along line 6-6 in FIG. 4 and also shows feeding solution 15 within fluid reservoir 20. After hanging the feeder using hangar tab 23 with attached hangar 21, the bottom cap is threaded onto fluid reservoir 20 until top edge 40a of the bottom cap makes contact with bottom flange 20c of the reservoir. In this feeding position, protrusion 44 has penetrated diaphragm 51 and feeding solution 15 has entered into cap cavity 41 of the bottom cap. The extent of the feeding solution is again shown by the horizontal broken lines.

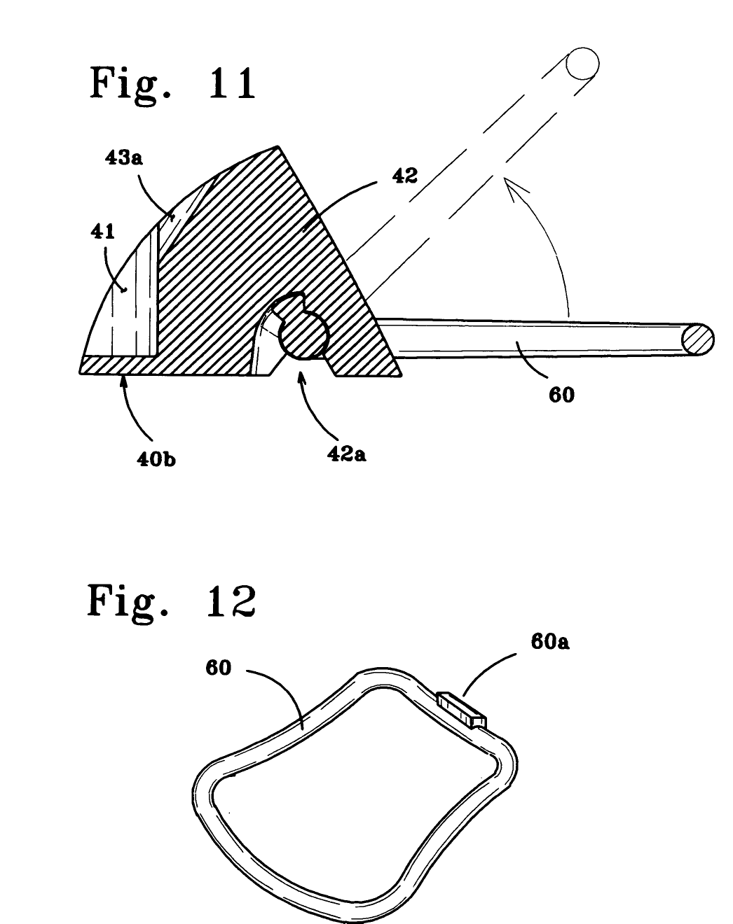

An enlarged cross-sectional view of FIG. 9A and a plan view of FIG. 10A are provided to clearly show bottom cap 40 details for the first embodiment. Cylindrical cap cavity 41 has internal cap threads 47 that mesh and lock with the external threads 27 of cylindrical bottom portion 25 of the fluid reservoir. Protrusion 44 extends into the cap cavity so that thin diaphragm 51 can be ruptured to allow feeding solution to enter the cap cavity and provide the second feeding configuration (see FIG. 6A). Cap sleeve 43 has a cylindrical sleeve aperture 43a to receive feeding tube 32 of feeding assembly 30. Top edge 40a of the bottom cap contacts bottom flange 40c of the reservoir when the feeder is in a feeding configuration. Perch support 42 has a perch recess 42a to receive a perch and allow the perch to rotate, as illustrated by the curved arrow in FIG. 11.

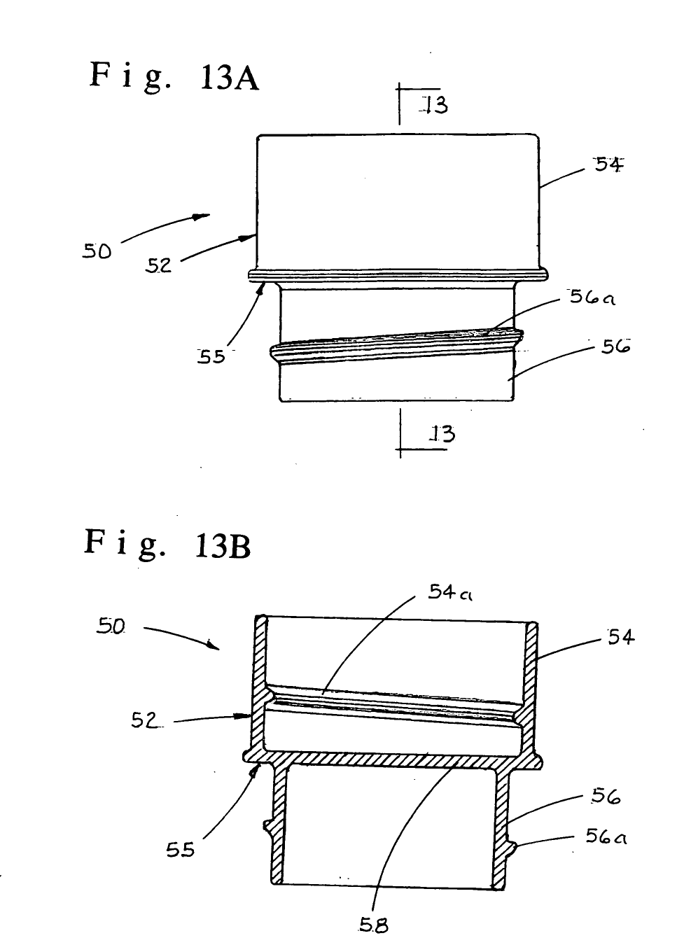

A second embodiment of the present invention is realized by modifying the first storage and shipping configuration of the first embodiment and the means to convert the feeder to the second feeder configuration. Essentially the modification includes removing protrusion 44 of bottom cap 40 that extends into cap cavity 41. Interface unit 50, to initially retain the feeding solution in the reservoir, has also been replaced by a removable reservoir sealer cap 52. The first storage and shipping configuration of the second embodiment is illustrated in FIG. 7B. A slight change in the shape of the fluid reservoir 120 is also noted. A different shape of the reservoir will not change the functionality of the present invention. A modified bottom cap 140 (without protrusion 44) replaces bottom cap 40 of the first embodiment, as illustrated in the enlarged cross-sectional view of FIG. 9B and the plan view of FIG. 10B and discussed below. Interface unit 50 becomes a reservoir sealer cap 52 as illustrated in FIGS. 13A and 13B. The sealer cap has a top portion 54 which has internal threads 54a that mesh with the external threads 27 of the fluid reservoir. A bottom portion 56 of the sealer cap has external threads 56a that mesh with internal threads 47 of bottom cap 140. A sealer diaphragm 58 separates the top and bottom portions. The first storage and shipping configuration is realized by threading the sealer cap into the bottom cap until top edge 140a contacts sealer cap flange 55. This connected pair is fully threaded onto the fluid reservoir which has been filled with feeding solution 15 to a full position 15a, as illustrated in FIG. 7B. The feeding solution is kept sealed in the reservoir by bottom edge 126 of the reservoir being sealed against sealer diaphragm 58.

The second feeding configuration of the second embodiment is illustrated in FIG. 6B. The second feeding configuration of the second embodiment is essentially the same as that illustrated for the first embodiment of FIGS. 1, 2 and 3. Sealer cap 52 has been removed and modified bottom cap 140 is threaded onto cylindrical bottom portion 25 of the reservoir until it stops, to provide a sealed interface between the bottom cap and the reservoir. Once the sealer cap is removed and bottom cap 140 is in place on the reservoir, the feeder is inverted to the feeding configuration. Once again, the internal threads of the modified bottom cap mesh and lock or semi-lock with the external threads of the fluid reservoir as in the first embodiment of FIG. 8. The feeding solution 15 flows into cap cavity 141 to be accessed by the hummingbird using feeding assembly 30, as described for the first embodiment.

A third embodiment of the present invention is again realized by modifying the first storage and shipping configuration of the first embodiment; as well as the steps to obtain the second feeder configuration. The third embodiment is illustrated in FIGS. 6B and 7C. In addition, FIGS. 1, 2 and 3 which are also essentially the same for this third embodiment, except for the same change in the shape of the fluid reservoir 120, as illustrated in the second embodiment. The modified bottom cap 140 without the protrusion again replaces bottom cap 40 of the first embodiment. The first shipping and storage configuration is realized by providing a “peel-away” diaphragm 53 as interface unit 50 at bottom edge 126 of reservoir 120. The modified bottom cap is again partially threaded onto cylindrical bottom portion of the reservoir to provide gap “G” between the bottom cap and the reservoir. The gap is provided to prevent the bottom cap from being locked onto the reservoir by the interlocking threads so it can be removed to remove the peel-away diaphragm.

The second feeding configuration of the third embodiment is realized by unthreading the bottom cap from the reservoir and removing the peel-away diaphragm. In the next step, the bottom cap is fully threaded in place on the reservoir and the feeder is inverted to the feeding configuration, as illustrated in FIG. 6B. The second feeding configuration of the third embodiment is the same as the second feeding configuration of the second configuration; having removed interface unit 50 in both embodiments. Again, the internal threads of the modified bottom cap mesh and semi-lock with the external threads of the fluid reservoir as in the first embodiment of FIG. 8. The feeding solution 15 flows into cap cavity 141 to be accessed by the hummingbird using one of the feeding assemblies as described below for the first, second and third embodiments.

A cross-sectional view of modified bottom cap 140 of the second and third embodiments is shown in FIG. 9B and the plan view is shown in FIG. 10B. These views compare with the views of the bottom cap 40 of the first embodiment illustrated in FIGS. 9A and 10A. As previously discussed, the obvious difference is the removal of protrusion 44 of the first embodiment to obtain the modified bottom cap 140 of the second and third embodiments. The exterior size and shape of the bottom cap 140 is the same as bottom cap 40. External threads 27 of the reservoir and the internal threads 47 of modified bottom cap 140 are again made to interlock one with the other.

The various components of recessed top 20b, perch supports 42, feeding assemblies 30 and perches 60 remain the same for the second embodiment as previously discussed for the first embodiment. In the remaining discussion any reference to the reservoir or the bottom cap refers equally to reservoir 20 or 120 and bottom cap 40 or 140.

For each embodiment a feeding assembly 30 having a feeding tube 32 and a feeding guide 34 is associated with each perch support 42, as best illustrated in FIGS. 6A and 6B. A cap sleeve 43 is made integral with each perch support to retain the feeding assembly. The feeding assembly can now be used by the hummingbird to access the feeding solution through a feeding tube aperture 31 of the feeding tube. The feeding tube is held in a sleeve aperture 43a of cap sleeve 43 by friction. In one aspect of the first embodiment of the invention, the feeding tube can be adjusted in and out of sleeve aperture 43a depending on the needs of each hummingbird. A feeding guide 34 is used to attract the hummingbird. The feeding guide is shaped to look like a flower and can be colored red to assist in this attraction. There is a plurality of feeding assemblies 30 positioned around the bottom cap. The preferred number of feeding assemblies is three.

Perches 60 assist the hummingbird by providing a place to rest, if necessary. The perch and the perch support are discussed in more detail by referring to FIGS. 11 and 12. An enlarged cross-sectional view of perch support 42 is shown in FIG. 11. Perch 60 snaps into a perch recess 42a in the bottom of the perch support. The perch is shown removed from the perch support in FIG. 12. The perch is in a horizontal position, as shown in FIG. 11, for the second feeding configuration. A perch stop 60a is provided to keep the perch essentially horizontal for the feeding hummingbird. The perch can be rotated upward (as shown by the dashed lines) into a vertical position for the first shipping and storage configuration to save space for shipping (see FIGS. 7A, 7B and 7C). Alternately, the perch can be removed and snapped into place when converting the feeder to the feeding configuration. In addition, a hovering hummingbird may prefer to access the feeding solution without using the perch.

The locking or semi-locking feature of the threaded connection between the fluid reservoir and the bottom cap is to protect the health of the hummingbird. A label can also be added to the outer surface to clearly warn the user against reusing the hummingbird feeder. The intent is to dispose of the hummingbird feeder when it is empty or the feeding solution has spoiled. The critical factor is to make the feeder a low cost feeder that can be disposed of after use. If the user is determined to reuse the feeder, simply forcing the threads of the reservoir back over the stop of the bottom cap will allow the user to refill the reservoir. However, the danger to the health of the hummingbird by reusing the feeder is well known by bird lovers. The locking feature is to protect the hummingbirds against the uninformed user.

The hummingbird feeder of this invention is to be marketed as a disposable unit. Therefore, a number of units are to be purchased at the same time; so that the user can immediately replace a hummingbird feeder when the feeding solution in one unit has been consumed, or is no longer useful. The preferred packaging means is to provide a carrying case which is very similar to a six-pack soft drink carton. A plastic shrink wrap is also acceptable for packaging a number of hummingbird feeders together.

The materials used for transparent fluid reservoir 20 are preferably clear plastic which is biodegradable or recyclable. The transparent feature of these materials allows the user to gage the amount of feeding solution 15 remaining in the fluid reservoir before the hummingbird feeder is replaced. The use of biodegradable or recyclable materials has become increasingly popular and great improvements are being made available in the industry for a composition of material for safe disposal and/or reuse.

The fluid reservoir is specifically designed to prevent spoilage by making the fluid reservoir small to provide only a few days supply of the feeding solution. Spoilage can cause intestinal problems for the hummingbirds. The preferred capacity is about one-half pint.

The preferred feeding solution 15 is a sugar solution generally called a nectar. The nectar will be free of preservatives. Preferably, the nectar is a twenty (20) percent sucrose invert, which has been processed to become a bacteria free aseptic solution. The aseptic feeding solution is added to fluid reservoir 20 prior to the point-of-sale to provide the best protection against contamination by the user. This process provides a longer shelf life of the feeding solution, which is both desirable at the point-of-sale and before being used by the user. A Ph change usually results in a visible change in color or clarity of the feeding solution. This change also informs the user that the feeding solution has spoiled.

An Insect inhibiting fluid is added to mote 22 of the recessed top 20b (see FIG. 1). The insect inhibiting fluid is preferably a non-toxic material. The material provides an effective barrier which prevents insects, and especially ants, from traveling down the hangar 21 to the feeding tube assembly and the feeding solution. The insect inhibiting fluid may also comprise some form of insecticide or agent or water treated with a wetting agent, such as soap.

While a preferred embodiment of the invention has been described using specific terms an a particular prior art reference, such description is for illustrative purposes only, and it is to be understood that changes and variations may be made without departing from the spirit or scope of the following claims. The foregoing is considered to be illustrative only of the principles of the invention. Since numerous modifications and changes will readily occur to those skilled in the art, it is not desirable to limit the invention to the exact construction and operation shown and described. Accordingly, all suitable modifications and equivalents may be resorted to, falling within the scope of this invention. All equivalent relationships to those illustrated in the drawings and described in the specifications are intended to be encompassed by the present invention.

What is claimed is:

1. A disposable hummingbird feeder comprising:
a transparent fluid reservoir filled with a feeding solution and having a closed and recessed top and an open cylindrical bottom portion with external threads between a bottom flange and a bottom edge of said reservoir;
a bottom cap having a cylindrical cap cavity with internal cap threads that mesh with said external threads of said fluid reservoir;
an interface unit to provide a first storage and shipping configuration of the feeder, wherein said feeding solution is sealed within said reservoir, and a second feeding configuration of the feeder, wherein said feeding solution enters said bottom cap cavity to be accessed by the hummingbird;
said bottom cap having cap sleeves and a top edge so that, in said first storage and shipping configuration said top edge of said bottom cap is spaced apart from said bottom flange of said reservoir and, in said second feeding configuration, said top edge of said bottom cap contacts said bottom flange of said reservoir to allow said feeding solution to enter said cap cavity; and
a plurality of feeding assemblies each positioned in a respective cap sleeve of said bottom cap to provide a feeding aperture for the hummingbird to access said feeding solution when said bottom cap is in said second feeding configuration.

2. The disposable hummingbird feeder of claim 1 wherein said bottom cap is formed with a plurality of perch supports that correspond with said plurality of feeding assemblies, said perch supports each rotatably supporting a perch that extends approximately vertical in said storage and shipping configuration of the feeder and is moved to approximately a horizontal position in said feeding configuration of the feeder, so that the hummingbirds can rest when using the feeder.

3. The disposable hummingbird feeder of claim 2 wherein said fluid reservoir, said bottom cap, said interface unit, said feeding assemblies and said perches are all made of a material that is biodegradable, so that the feeder can be discarded without being a waste hazard.

4. The disposable hummingbird feeder of claim 3 wherein said fluid reservoir, said interface unit, said bottom cap, said feeding assemblies and said perches are all made of a material that is recyclable, so that the feeder material can be reused.

5. The disposable hummingbird feeder of claim 1 wherein each one of said plurality of feeding assemblies includes:
a red colored feeding guide in the form of a flower to attract a hummingbird;
a feeding tube that is held in said cap sleeve of said bottom cap by friction so that said feeding tube provide the proper distance between said feeding guide and said feeding solution in said cap cavity for the feeding hummingbird; and
said feeding tube having an aperture to provide access for the hummingbird to said feeding solution in said cap cavity.

6. The hummingbird feeder of claim 1 wherein said recessed top portion of said reservoir includes a hangar tab with an aperture to receive a hangar to hang the hummingbird feeder in an optimum location.

7. The hummingbird feeder of claim 7 wherein said recessed top portion provides a moat to receive an insect inhibiting material to form a barrier against insects reaching said feeding solution.

8. The hummingbird feeder of claim 1 wherein said feeding solution is a 20 percent sucrose invert which has been treated to produce a cleansing of the feeding solution to obtain an aseptic solution which is bacteria free for improved shelf-life of the feeder and for making the feeding solution safe for consumption by the hummingbird; as seen by an obvious change in appearance of said feeder solution when it becomes unsafe.

9. The hummingbird feeder of claim 1 wherein said fluid reservoir has a preferred capacity of about eight liquid ounces (one-half pint or 275 ml) to provide added safety by limiting the usable lifespan of the feeder.

10. The disposable feeder of claim 1 wherein the interfaces assembly comprises:
a thin diaphragm attached to said bottom edge of said reservoir to retain said feeding solution within said reservoir during said storage and shipping configuration; and
a protrusion built integral with said bottom cap that extends upward into said cylindrical cap cavity to penetrate said diaphragm when said bottom cap is threaded onto said reservoir to said second feeding position.

11. The disposable hummingbird feeder of claim 10 wherein said external threads of said fluid reservoir mesh with said internal cap threads of the bottom cap to form a locking mechanism to help keep the hummingbird feeder from being reused by adding more feeding solution to said fluid reservoir.

12. The disposable feeder of claim 1 wherein the interfaces assembly comprises:
a reservoir sealer cap having an upper portion with internal threads that mesh with said external threads of said reservoir, and a bottom portion with external threads that mesh with said internal cap threads of said bottom cap, wherein said sealer cap is threaded onto said reservoir to seal said feeding solution within said reservoir and said bottom cap is threaded onto said sealer cap to provide said first storage and shipping configuration, and wherein the sealer cap is completely removed and said bottom cap is threaded onto said external threads of said reservoir to provide said second feeding configuration.

13. The disposable hummingbird feeder of claim 12 wherein said external threads of said fluid reservoir mesh with said internal reservoir sealer cap threads to form a semi-locking mechanism to provide positive feedback to the user that a good seal was made and limit the ability of the user to later remove said bottom cap from said reservoir and refill said reservoir.

14. A disposable hummingbird feeder assembly comprising:
a transparent fluid reservoir filled with a feeding solution and having a closed top portion with a top recess forming a moat with a hangar tab for a hangar and an open cylindrical bottom portion with external threads between a bottom flange and a bottom edge of said reservoir;
an interface unit comprising a peel-away diaphragm supported by and sealed against said bottom edge of said reservoir to initially retain said feeding solution within said reservoir;
a bottom cap having a top surface, a cylindrical cap cavity with internal cap threads that mesh with said external threads of said reservoir, a bottom surface and a plurality of perch supports each with a cap sleeve, wherein the feeder has a first storage and shipping configuration where said bottom cap is partially threaded onto said reservoir until said top edge of said bottom cap is spaced apart from said bottom flange of said reservoir and a second feeding configuration where said peel-away diaphragm is removed from said bottom edge of said reservoir, said bottom cap is threaded onto the reservoir until said top edge of said bottom cap contacts said bottom flange of said reservoir and said feeding solution flows into said cap cavity to be accessed by the hummingbird through said feeding assemblies when the feeder is hanging in an optimum location using said hangar; and
a plurality of feeding assemblies, each supported by said bottom cap using a respective cap sleeve to provide feeding apertures for the hummingbird to access said feeding solution.

15. The hummingbird feeder assembly of claim 14, wherein said fluid reservoir, said peel-away diaphragm, said bottom cap and said feeding assemblies are all made of a material that is biodegradable so the feeder can be discarded without being a waste hazard.

16. The hummingbird feeder assembly of claim 14 wherein said fluid reservoir, said peel-away diaphragm, said bottom cap and said feeding assemblies are all made of a material that is recyclable so that the feeder material can be reused.

17. The hummingbird feeder of claim 14 including a perch carried by each one of said perch supports that folds up to be approximately vertical for storage and extends approximately horizontally for access by the hummingbird while feeding, wherein said perches are made of the same material as the other components of the feeder.

18. The hummingbird feeder assembly of claim 14 wherein said feeding solution is a twenty (20) percent sucrose invert which has been treated to produce a cleansing of the feeding solution to obtain an aseptic solution which is bacteria free for improved shelf-life of the feeding solution and for making the feeding solution safe for consumption by the hummingbird; as seen by an obvious change in appearance of said feeder solution when it becomes unsafe.

19. The hummingbird feeder assembly of claim 14 wherein each one of said plurality of feeding assemblies includes:
a red colored feeding guide to attract a hummingbird;
a feeding tube extending from said feeding guide that is adjustably held in said cap sleeve of said bottom cap by friction so that said feeding tube slides in and out of said cap sleeve to provide the proper distance between said feeding guide and said feeding solution in said cap cavity for the feeding hummingbird; and
said feeding tube having an aperture to provide access for the hummingbird to said feeding solution in said cap cavity of said bottom cap.

20. A method to provide a disposable hummingbird feeder including the steps of:
a) providing a transparent fluid reservoir having a closed and recessed top with a hangar and an open cylindrical bottom portion with external threads between a bottom flange and a bottom edge;
b) providing a reservoir sealer cap having a top portion with internal threads that mesh with said external threads of said reservoir and a bottom portion with external threads between a sealer diaphragm and a bottom edge of the sealer;
c) providing a bottom cap having a cylindrical cap cavity with internal cap threads that mesh with said external threads of said reservoir sealer cap, perch supports with cap sleeves, a top flange and a bottom surface;
d) inverting said reservoir and filling said reservoir with a feeding solution;
e) threading said sealer cap onto said reservoir and said bottom cap onto said sealer cap to obtain a first storage and shipping configuration of the feeder prior to using the feeder;
f) inverting said feeder and removing said bottom cap and sealer cap from said reservoir as a first step in placing the feeder into service;
g) removing said sealer cap from said bottom cap and threading said bottom cap onto said reservoir until it clicks through a semi-locked position;
h) providing and connecting perches to said perch supports and inserting feeding assemblies into said cap sleeves;
i) inverting said feeder to obtain an upright feeding configuration allowing said feeding solution to enter said cap cavity to be retained by said bottom surface of said bottom cap;
j) hanging the feeder in an appropriate location using said hangar;
k) moving said perches to approximately a horizontal position so that the hummingbird can rest while accessing said feeding solution within said cap cavity through said feeding assemblies;
l) disposing of the feeder when the feeding solution has either one of spoiled or has been consumed by the hummingbirds.

21. The method of claim 20 further including the step of making the fluid reservoir, the bottom cap, the perches and the feeding assemblies of a material which is one of either biodegradable or recyclable.

22. The method of claim 20 wherein the step of providing a recessed top of the reservoir includes the step of adding a liquid material to form a mote against insects reaching said feeding solution and wherein the step of providing said feeding assemblies further includes the steps of;
providing a red colored feeding guide in the form of a flower to attract hummingbirds;
providing a feeding tube that is adjustably held in said cap sleeve of said bottom cap by friction for providing the proper distance between said feeding guide and said feeding solution in said cap cavity for the feeding hummingbird; and
providing said feeding tube with an aperture for allowing access by the hummingbird to said feeding solution in said cap cavity of said bottom cap.

23. The method of claim 20 wherein the step of providing a feeding solution includes the step of treating the chemical substance to provide an aseptic solution that is bacteria free for improving the shelf life of the feeding solution and extending the useful life of the feeding solution.
